(19) United States
(12) Patent Application Publication
(10) Pub. No.: US 2021/0348973 A1
(43) Pub. Date: Nov. 11, 2021

(54) MONOMOLECULAR SUBSTRATE STRAIN SENSING DEVICE AND MANUFACTURING METHOD THEREOF

(71) Applicant: WUHAN CHINA STAR OPTOELECTRONICS TECHNOLOGY CO., LTD., Wuhan, Hubei (CN)

(72) Inventor: Chengzhi LUO, Wuhan, Hubei (CN)

(21) Appl. No.: 16/478,037

(22) PCT Filed: Mar. 25, 2019
(86) PCT No.: PCT/CN2019/079499

§ 371 Date: Jul. 15, 2019

(30) Foreign Application Priority Data
Dec. 29, 2018 (CN) 201811637865.3

(51) Int. Cl. G01L 1/24; G01N 21/65

(52) U.S. Cl. CPC G01L 1/24; G01N 21/65

(57) ABSTRACT

The present disclosure proposes a monomolecular substrate strain sensing device and a manufacturing method thereof. The device includes a substrate, a monomolecular substance, and a Raman spectrometer. The monomolecular substance is attached to a surface of the substrate in a predetermined direction. Two terminals of the monomolecular substance are fixed in the surface of the substrate. The Raman spectrometer is arranged above the substrate. When the monomolecular carbon nanotube is strained, a measured G′ peak shift of a monomolecular carbon nanotube represents the strain amount of the substrate. Accordingly, detecting a tiny strain of a microdomain of the substrate is advantageous for improving the production precision and production efficiency of industries.

### BACKGROUND

### 1. Field of the Disclosure

The present disclosure relates to the field of the display technology, and more particularly, to a monomolecular substrate strain sensing device and a method of manufacturing the monomolecular substrate strain sensing device.

### 2. Description of the Related Art

In the field of display manufacturing and chip manufacturing, it is necessary to form microscopic patterns on a glass substrate or silicon substrate by a series of processes such as film formation, exposure, etching, etc. However, temperature changes and top pillars may cause strain on the substrate during the manufacturing process, thereby affecting the accuracy of the microscopic pattern. Thus, the strain of the substrate needs to be monitored to adjust the processing parameters. Nowadays, the difficulty in monitoring the substrate strain is that the strain area and the strain are too small, and the measurement technology is difficult to meet the requirements.

Currently, the frequently used strain measurement technique includes resistance measurement, optical measurement, electron microscopy, and nanoindentation technique. These methods are not applicable to a microdomain of a substrate and the measurement of the tiny strain. For example, resistance measurements require a resistor patch to be mounted in the millimeter range, and the tiny strain cannot be measured. Optical measurements are suitable for large deformation fields with insufficient resolution. An electron microscope (a scanning electron microscope, a transmission electron microscope, etc.) fails to monitor substrate deformation in real time during manufacturing. Nanoindentation damages the substrate a lot. Therefore, to effectively monitor the tiny strain of the substrate, to improve the accuracy of the product, and further to enhance company's competitiveness on the market are the main focus for the industry of panels and chips.

The monomolecular device serves as a sensing medium by measuring physical and chemical changes of the monomolecular device caused by the substrate strain to characterize the tiny strain from the microdomain, which is a feasible way now.

Therefore, it is necessary to propose a new monomolecular substrate strain sensing device and a method of manufacturing the monomolecular substrate strain sensing device.

### SUMMARY

The present disclosure proposes a monomolecular substrate strain sensing device and a method of manufacturing the monomolecular substrate strain sensing device to resolve the technical problem that the strain area of the substrate and the strain amount both are too small and it is hard for the measurement technology to meet the requirement.

According to a first aspect of the present disclosure, a monomolecular substrate strain sensing device includes a substrate, a monomolecular substance, and a Raman spectrometer. A surface of the substrate is provided with a regular pattern. A size of a microdomain of the substrate is 1 um×1.5 um. The monomolecular substance is attached to the surface of the substrate in a predetermined direction. Two terminals of the monomolecular substance is fixed in the surface of the substrate. The Raman spectrometer is arranged above the substrate and configured to detect a Raman curve of the monomolecular substance when the substrate is strained.

According to the present disclosure, the monomolecular substance is a single-walled carbon nanotube (SWNT).

According to the present disclosure, a length of the SWNT ranges from 0.5 um to 5 um.

According to the present disclosure, the regular pattern covers the entire microdomain.

According to the present disclosure, the regular pattern is regularly arranged by a plurality of golden patterns, each of which is shaped as an equilateral triangle.

According to the present disclosure, the lateral length of the golden pattern ranges from 50 nm to 100 nm.

According to the present disclosure, molybdenum (Mo) is deposited on the two terminals of the SWNT; the Mo fixes the two terminals of the SWNT on the surface of the substrate.

According to the present disclosure, the substrate is a glass substrate or a silicon wafer substrate.

According to a second aspect of the present disclosure, a monomolecular substrate strain sensing device includes a substrate, a monomolecular substance, and a Raman spectrometer. A surface of the substrate is provided with a regular pattern. The monomolecular substance is attached to the surface of the substrate in a predetermined direction. Two terminals of the monomolecular substance is fixed in the surface of the substrate. The Raman spectrometer is arranged above the substrate and configured to detect a Raman curve of the monomolecular substance when the substrate is strained.

According to the present disclosure, the monomolecular substance is a single-walled carbon nanotube (SWNT).

According to the present disclosure, a length of the SWNT ranges from 0.5 um to 5 um.

According to the present disclosure, the regular pattern is regularly arranged by a plurality of golden patterns, each of which is shaped as an equilateral triangle.

According to the present disclosure, the lateral length of the golden pattern ranges from 50 nm to 100 nm.

According to the present disclosure, molybdenum (Mo) is deposited on the two terminals of the SWNT; the Mo fixes the two terminals of the SWNT on the surface of the substrate.

According to the present disclosure, the substrate is a glass substrate or a silicon wafer substrate.

According to a third aspect of the present disclosure, a method of manufacturing a monomolecular substrate strain sensing device includes: Step S10: forming a monomolecular substance on a surface of a aluminum foil, wherein the monomolecular substance is a single-walled carbon nanotubes (SWNT); Step S20: forming a regular pattern on the surface of the substrate which needs to be tested; Step S30: transferring the SWNT arranged on the surface of the aluminum foil to the surface of the substrate with a nanomanipulator; Step S40: depositing molybdenum (Mo) on two terminals of the SWNT, which is transferred to the surface of the substrate; the two terminals of the SWNT being fixed on the surface of the substrate with the Mo; Step S50: detecting, by a Raman spectrometer, a first peak position of a Raman curve of the SWNT when the substrate is not strained; Step S60: detecting, by a Raman spectrometer, a second peak position of the Raman curve when the substrate is strained; Step S70: determining a shift amount between the first peak position and the second peak position by comparing the second peak position with the first peak position, to obtain the strain amount of the substrate according to the shift amount.

According to the present disclosure, the SWNT is produced on the surface of the aluminum foil with floating catalyst chemical vapor deposition in Step S10.

According to the present disclosure, the regular pattern is regularly arranged by a plurality of golden patterns, each of which is shaped as an equilateral triangle.

The present disclosure brings some benefits. A monomolecular substrate strain sensing device and a manufacturing method thereof is proposed by the present disclosure. The monomolecular substrate strain sensing device is characterized by the strain of the substrate by utilizing the Raman G′ peak shift of a monomolecular carbon nanotube during the strain. So it is possible to detect the tiny strain of a microdomain of a substrate, which is advantageous for improving the production precision and production efficiency of industries such as displays and semiconductors.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of a monomolecular substrate strain sensing device according to an embodiment of the present disclosure.

FIG. 2 illustrates a relationship between the strains of the SWNT and the G′ peak positions.

FIGS. 3A-3F illustrate diagrams of a method of manufacturing the monomolecular substrate strain sensing device according to another embodiment of the present disclosure.

FIG. 4 illustrates a flowchart of a method of manufacturing the monomolecular substrate strain sensing device according to still another embodiment of the present disclosure.

### DETAILED DESCRIPTION OF THE EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

The present disclosure proposes a monomolecular substrate strain sensing device and a method of manufacturing the monomolecular substrate strain sensing device. The adoption of the present disclosure solves the technical problem that the strain area of the substrate and the strain amount both are too small for the measurement technology to meet the requirement.

### Embodiment 1

As illustrated in FIG. 1, the present embodiment proposes a monomolecular substrate strain sensing device 100. Because the monomolecular substance is a substance that is sensitive to the strain and easy to be detected, the single molecule material can be a sensing medium to characterize the tiny strain of a microdomain of the substrate by measuring the physicochemical changes of the single molecule caused by the strain of the substrate. A single-walled carbon nanotube (SWNT) is a one-dimensional tubular structure of a single-layer graphene with a nanometer-scale diameter and crimped in a certain way. Since the SWNT has a high length to diameter ratio, a high temperature structure is stable, and the vibration frequency of carbon atoms changes when subjected to strain, it is very suitable for detecting the strain of the substrate. So the single molecule substance can be chosen as SWNT. The chosen single molecule in the present embodiment is SWNT.

A monomolecular substrate strain sensing device 100 provided by the present embodiment includes a substrate 11, a SWNT12, and a Raman spectrometer 13

The surface of the substrate 11 is provided with a regular pattern.

The SWNT12 is attached to the surface of the substrate 11 in a predetermined direction, and two terminals of the SWNT12 are fixed in the surface of the substrate 11.

The Raman spectrometer 13 is arranged above the substrate 11 and configured to collect the Raman curve of the SWNT12 when the substrate 11 is strained.

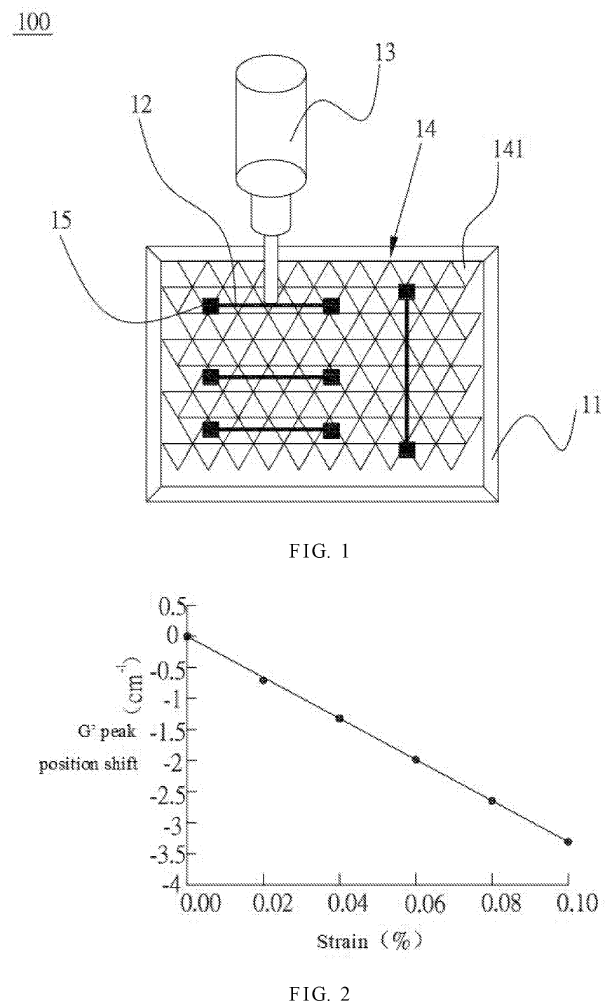

The G′ peak position of the Raman spectrum is very sensitive to the radial vibration of the SWNT12. When the vibration frequency of the SWNT12 changes, the G′ peak position of the Raman spectrum shifts. So the Raman spectrum can detect strain. While the strain of the SWNT12 gradually becomes greater, the G′ peak position gradually becomes smaller, as illustrated in FIG. 2.

The substrate 11 may be a glass substrate or a silicon wafer substrate. The regular pattern 14 is formed on the substrate 11. The regular pattern 14 may be regularly arranged by a golden (Au) pattern 141 with an equilateral triangle shape. Since the Raman signal of the single SWNT12 is weak, it is difficult to be detected by the Raman spectrometer 13. The conductive property of Au is good, the Raman spectrum can be enhanced by the regular pattern 14 which is regularly arranged by the Au pattern 141, thereby improving the detection sensitivity. The lateral length of the Au pattern 141 ranges from 50 nm to 100 nm (nm is short for nanometer). The regular pattern 14 covers the entire microdomain of the substrate 11 which needs to be detected.

For the strain of the microdomain in different ranges on the substrate 11, the SWNT12 with different lengths should be chosen. The present embodiment adopts a microdomain in the substrate 11 with a size of 1 um×1.5 um (um is short for micrometer), so the length of the SWNT12 should be maintained at 0.5-5 um. The shape of the SWNT12 attached to the surface of the substrate 11 should be kept flat so that the direction in which the SWNT12 is strained is in a straight line. Meanwhile, the arrangement direction of the SWNT12 on the upper surface of the substrate 11 can be adjusted according to the strain direction of the substrate 11 to be tested. For example, the arrangement direction of the SWNT12 on the upper surface of the substrate 11 can be kept in line with the strain direction of the substrate 11.

Molybdenum (Mo) 15 is deposited on the two terminals of the SWNT12. The Mo 15 fixes the two terminals of the SWNT12 on the upper surface of the substrate 11. The strain of the substrate 11 can be completely converted into the strain of the SWNT12, which improves the accuracy of measurement. If the two terminals of the SWNT12 are not fixed to the upper surface of the substrate 11, only Van der Waals forces exist between the SWNT12 and the substrate 11. The van der Waals force between the molecules is relatively weak. Once the substrate 11 is strained, the SWNT12 does not undergo the same deformation as the substrate 11 does, which will affect the result of measurement.

When the substrate 11 is strained, the Raman spectrometer 13 is placed above the single SWNT12 to collect a second peak position from the chosen Raman curve. The second peak position can be found out in the collected Raman curve. Compared the second peak position with the first peak position in the Raman curve of the collected SWNT12 when the substrate 11 is not strained, the offset of the peak position is obtained. According to the amount of the peak position offset corresponding to the relationship between diverse strain conditions of the SWNT12 and the Raman peak offset in FIG. 2, the strain amount of SWNT12 can be obtained.

Further, the strain amount of the substrate 11 can be obtained.

### Embodiment 2

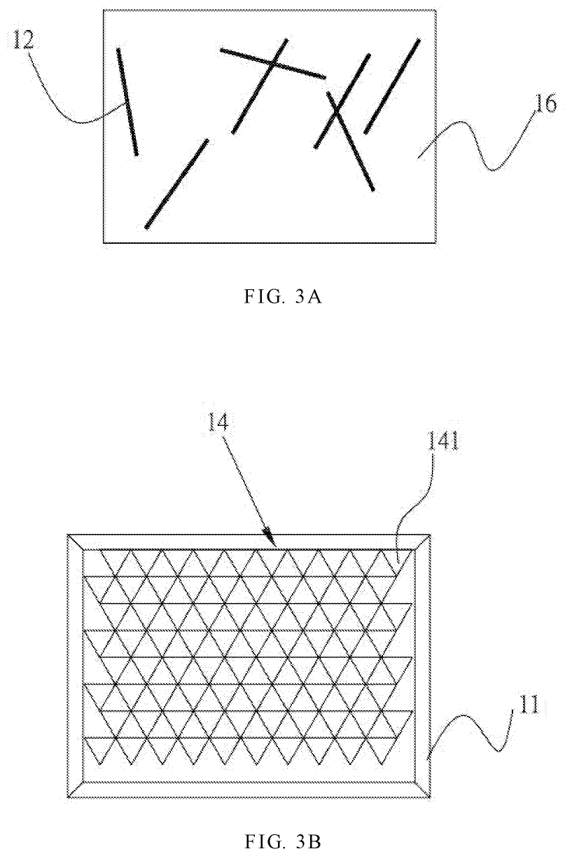

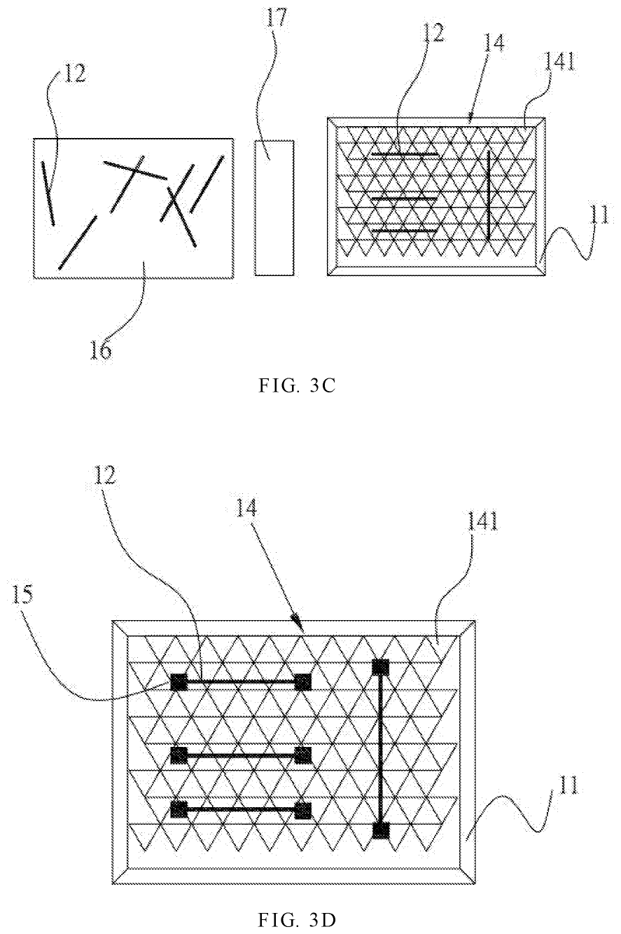

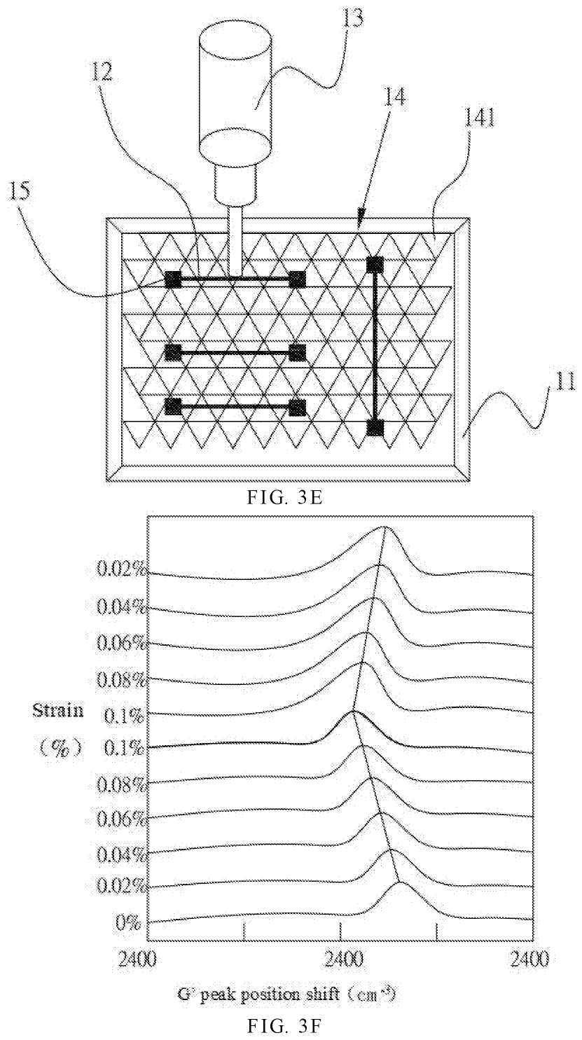

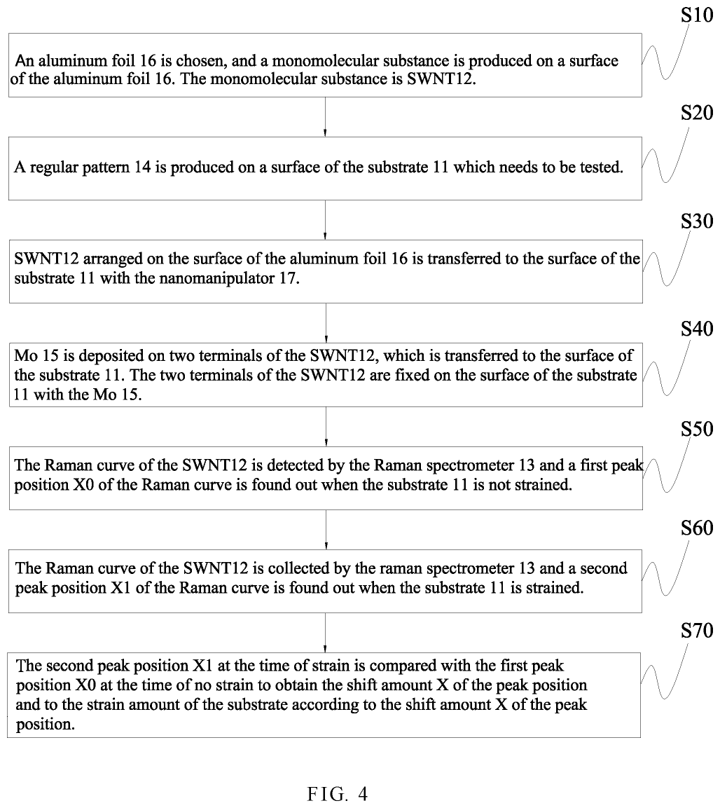

As FIG. 3A to FIG. 3F illustrate, a second embodiment of the present disclosure proposes a method of manufacturing a monomolecular substrate strain sensing device. Take the strain from a microdomain with a size of 1 um×1.5 um (um is short for micrometer) on a substrate 11 as an example for elaboration. The manufacturing method includes block S10, block S20, block S30, block S40, block S50, block S60, and block S70.

At block S10, an aluminum foil 16 is chosen, and a monomolecular substance is produced on a surface of the aluminum foil 16. The monomolecular substance is SWNT12.

As illustrated in FIG. 3A, an aluminum foil 16 is chosen. The SWNT12 is produced on the surface of the aluminum foil 16 with floating catalyst chemical vapor deposition. The SWNT12 produced by the method has high purity, simple equipment, and low cost.

Meanwhile, in order to facilitate the subsequent transfer of the SWNT12 to the upper surface of the substrate 11, the density of the SWNT12 cannot be too high and the winding between the SWNTs 12 cannot occur. In this way, the performance of SWNT12 will not be affected.

At block S20, a regular pattern 14 is produced on a surface of the substrate 11 which needs to be tested.

As illustrated in FIG. 3B, the substrate 11 may be a glass substrate or a silicon wafer substrate. In the present embodiment, the substrate 11 is a glass substrate. A regular pattern 14 is formed on the surface of the substrate 11. The regular pattern 14 is regularly arranged by an Au pattern 141 in an equilateral triangle shape. The Au pattern 141 uniformly and densely covers the substrate 11. The Raman signal of the single SWNT12 is weak so it is difficult to be detected. Because Au has good conductivity, a regular pattern 14 regularly arranged by the Au pattern 141 on the substrate 11 can enhance Raman. In the present embodiment, the shape of the Au pattern 141 is an equilateral triangle, but the shape of the Au pattern 141 may be another shape, which is not limited in the present disclosure.

At block S30, the SWNT12 arranged on the surface of the aluminum foil 16 is transferred to the surface of the substrate 11 with the nanomanipulator 17.

As illustrated in FIG. 3C, in the process of transferring the SWNT12 to the upper surface of the substrate 11 on which an Aurum (Au) pattern 141 is deposited, it is necessary to choose the SWNT12 with a proper length and no bending. It is ensured that the SWNT12 can be completely placed on the upper surface of the substrate 11. Meanwhile, the arrangement direction of the SWNT12 on the upper surface of the substrate 11 can be adjusted according to the strain direction of the substrate 11 which needs to be tested. For example, the arrangement direction of the SWNT12 on the upper surface of the substrate 11 can be kept in line with the strain direction of the substrate 11.

At block S40, molybdenum (Mo) 15 is deposited on two terminals of the SWNT12, which is transferred to the surface of the substrate 11. The two terminals of the SWNT12 are fixed on the surface of the substrate 11 with the Mo 15.

The metal Mo 15 is deposited on the two terminals of the SWNT12 so as to fix the two terminals of the SWNT12 on the upper surface of the substrate 11, as illustrated in FIG. 3D. When the two terminals of the SWNT12 are not fixed, only Van der Waals force exists between the SWNT12 and the substrate 11. When the substrate 11 is strained, the SWNT12 does not undergo the same deformation as the substrate 11 does, which may affect the test result.

At block S50, the Raman curve of the SWNT12 is detected by the Raman spectrometer 13 and a first peak position X0 of the Raman curve is found out when the substrate 11 is not strained.

When the substrate 11 is not strained, the Raman spectrometer 13 is arranged above the single SWNT12 and detects the Raman curve of the SWNT12, as illustrated in FIG. 3E. The G′ peak position X0 (i.e., the first peak) can be found out in the collected Raman curve.

At block S60, the Raman curve of the SWNT12 is collected by the Raman spectrometer 13 and a second peak position X1 of the Raman curve is found out when the substrate 11 is strained.

When the substrate 11 is strained, the Raman spectrometer 13 is arranged above the single SWNT12 and collects the Raman curve of the SWNT12, as illustrated in FIG. 3E. The G′ peak position X1 (i.e., the second peak) can be found out in the collected Raman curve.

At block S70, the second peak position X1 at the time of strain is compared with the first peak position X0 at the time of no strain to obtain the shift amount X of the peak position and to the strain amount of the substrate according to the shift amount X of the peak position.

As illustrated in FIG. 3F, the Raman curve of SWNT12 strain is collected by the Raman spectrometer 13. With the Raman curve, the G′ peak position can be easily obtained. Compared the second peak position X1 in the Raman curve of the SWNT12 collected when the substrate 11 is strained with the first peak position X0 in the Raman curve of the SWNT12 collected when the substrate 11 is not strained, the peak position offset X=X1−X0 can be obtained. Furthermore, according to the relationship between the different strains of SWNT12 and the offset of the Raman G′ peak, the strain of SWNT12 can be obtained, and the strain of substrate 11 can be obtained.

The manufacturing method proposed by the embodiment of the present disclosure is to measure the strain of a single node of the substrate 11. In addition, the method can also detect the strain distribution by using the Raman surface scanning function, and details are not described herein again.

The present disclosure brings some benefits. A monomolecular substrate strain sensing device and a manufacturing method thereof is proposed by the present disclosure. The monomolecular substrate strain sensing device is characterized by the strain of the substrate by utilizing the Raman G′ peak shift of a monomolecular carbon nanotube during the strain. So it is possible to detect the tiny strain of a microdomain of a substrate, which is advantageous for improving the production precision and production efficiency of industries such as displays and semiconductors.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A monomolecular substrate strain sensing device, comprising:
a substrate, a surface of the substrate being provided with a regular pattern, wherein a size of a microdomain of the substrate is 1 um×1.5 um;
a monomolecular substance, attached to the surface of the substrate in a predetermined direction, wherein two terminals of the monomolecular substance is fixed in the surface of the substrate; and
a Raman spectrometer, arranged above the substrate and configured to detect a Raman curve of the monomolecular substance when the substrate is strained.

2. The monomolecular substrate strain sensing device of claim 1, wherein the monomolecular substance is a single-walled carbon nanotube (SWNT).

3. The monomolecular substrate strain sensing device of claim 2, wherein a length of the SWNT ranges from 0.5 um to 5 um.

4. The monomolecular substrate strain sensing device of claim 1, wherein the regular pattern covers the entire microdomain.

5. The monomolecular substrate strain sensing device of claim 1, wherein the regular pattern is regularly arranged by a plurality of golden patterns, each of which is shaped as an equilateral triangle.

6. The monomolecular substrate strain sensing device of claim 5, wherein the lateral length of the golden pattern ranges from 50 nm to 100 nm.

7. The monomolecular substrate strain sensing device of claim 2, wherein molybdenum (Mo) is deposited on the two terminals of the SWNT; the Mo fixes the two terminals of the SWNT on the surface of the substrate.

8. The monomolecular substrate strain sensing device of claim 1, wherein the substrate is a glass substrate or a silicon wafer substrate.

9. A monomolecular substrate strain sensing device, comprising:
a substrate, a surface of the substrate being provided with a regular pattern;
a monomolecular substance, attached to the surface of the substrate in a predetermined direction, wherein two terminals of the monomolecular substance is fixed in the surface of the substrate; and
a Raman spectrometer, arranged above the substrate and configured to detect a Raman curve of the monomolecular substance when the substrate is strained.

10. The monomolecular substrate strain sensing device of claim 9, wherein the monomolecular substance is a single-walled carbon nanotube (SWNT).

11. The monomolecular substrate strain sensing device of claim 10, wherein a length of the SWNT ranges from 0.5 um to 5 um.

12. The monomolecular substrate strain sensing device of claim 9, wherein the regular pattern is regularly arranged by a plurality of golden patterns, each of which is shaped as an equilateral triangle.

13. The monomolecular substrate strain sensing device of claim 12, wherein the lateral length of the golden pattern ranges from 50 nm to 100 nm.

14. The monomolecular substrate strain sensing device of claim 10, wherein molybdenum (Mo) is deposited on the two terminals of the SWNT; the Mo fixes the two terminals of the SWNT on the surface of the substrate.

15. The monomolecular substrate strain sensing device of claim 9, wherein the substrate is a glass substrate or a silicon wafer substrate.

16. A method of manufacturing a monomolecular substrate strain sensing device, comprising:
Step S10: forming a monomolecular substance on a surface of a aluminum foil, wherein the monomolecular substance is a single-walled carbon nanotubes (SWNT);
Step S20: forming a regular pattern on the surface of the substrate which needs to be tested;
Step S30: transferring the SWNT arranged on the surface of the aluminum foil to the surface of the substrate with a nanomanipulator;
Step S40: depositing molybdenum (Mo) on two terminals of the SWNT, which is transferred to the surface of the substrate; the two terminals of the SWNT being fixed on the surface of the substrate with the Mo;
Step S50: detecting, by a Raman spectrometer, a first peak position of a Raman curve of the SWNT when the substrate is not strained;
Step S60: detecting, by a Raman spectrometer, a second peak position of the Raman curve when the substrate is strained;
Step S70: determining a shift amount between the first peak position and the second peak position by comparing the second peak position with the first peak position, to obtain the strain amount of the substrate according to the shift amount.

17. The method of manufacturing the monomolecular substrate strain sensing device of claim 16, wherein the SWNT is produced on the surface of the aluminum foil with floating catalyst chemical vapor deposition in Step S10.

18. The method of manufacturing the monomolecular substrate strain sensing device of claim 16, wherein the regular pattern is regularly arranged by a plurality of golden patterns, each of which is shaped as an equilateral triangle.
